(19) United States
(12) Patent Application Publication
(10) Pub. No.: US 2024/0070625 A1
(43) Pub. Date: Feb. 29, 2024

(54) SYSTEMS AND METHODS FOR GENERATING AND AUTHENTICATING USE OF A VOUCHER ASSOCIATED WITH A RESOURCE IN A DISTRIBUTED NETWORK

(71) Applicant: BANK OF AMERICA CORPORATION, Charlotte, NC (US)

(72) Inventors: Jennifer Tiffany Renckert, Middleburg, FL (US); Mary Clark, Plano, TX (US); Mayakoothan Krishnan, Frisco, TX (US); Nagalakshmi Nagendra, Frisco, TX (US); Nariah Uchechi Kamalu Barnes, Charlotte, NC (US); Nicholas Stephen Rose, Charlotte, NC (US); Nicolas Kouamou Kabse, Heartland, TX (US); Tyler McFadden, Wingate, NC (US)

(73) Assignee: BANK OF AMERICA CORPORATION, Charlotte, NC (US)

(21) Appl. No.: 17/898,122

(22) Filed: Aug. 29, 2022

(51) Int. Cl. G06Q 20/04; G06Q 20/40

(52) U.S. Cl. CPC G06Q 20/0457; G06Q 20/40

(57) ABSTRACT

Systems, computer program products, and methods are described herein for generating and authenticating use of a voucher associated with a resource in a distributed network. A distribution authentication system, like that described herein, is configured to generate a resource voucher based on a resource distribution from a transferor account to a recipient account, the resource voucher comprising an expiration period; receive a request for a voucher distribution; and authenticate, in response to receiving the request for the voucher distribution, whether the voucher distribution has met the expiration period, wherein, in the instance where the voucher distribution has met the expiration period, automatically redistribute the resource distribution to the transferor account.

### FIELD OF THE INVENTION

The present invention embraces a system for generating and authenticating use of a voucher associated with a resource in a distributed network.

### BACKGROUND

Users and accounts associated with such users in a distributed network have a harder time than ever authenticating resource distributions after resources have been distributed from their account to another account, such as a recipient account. Such authentication and control of the distribution(s) may be necessary where specific events should take place, as outlined by the transferor, in order for the resource to properly be distributed by the recipient. Current systems fail to both track such specific events, authenticate the distribution(s) to make sure such specific events have occurred before allowing the distribution from the recipient account to take place, and automatically redistribute the resource distribution back to the transferor account where the specific events have been confirmed not to have occurred. Specifically, there exists a need for strong tracking, authentication, and controlling mechanisms for distributions in a distributed network where a distribution may undergo transmission between a plurality of accounts that are not directly controlled by an original transferor associated with a transferor account.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect of the invention, a system for generating a personalized voucher comprising automatic return resource distribution at specified events is provided. The system comprising: a memory device with computer-readable program code stored thereon; at least one processing device operatively coupled to the at least one memory device and the at least one communication device, wherein executing the computer-readable code is configured to cause the at least one processing device to: generate a resource voucher based on a resource distribution from a transferor account to a recipient account, the resource voucher comprising an expiration period; receive a request for a voucher distribution; and authenticate, in response to receiving the request for the voucher distribution, whether the voucher distribution has met the expiration period, wherein, in the instance where the voucher distribution has met the expiration period, automatically redistribute the resource distribution to the transferor account.

In some embodiments, the processing device of the system is further configured to: receive a request for a voucher distribution, wherein the voucher distribution comprises a portion of the resource distribution; and determine, in response to receiving the request for the voucher distribution, whether the voucher distribution has met the expiration period, wherein, in the instance where the voucher distribution has not met the expiration period, automatically transmit the voucher distribution to an identified account by the recipient account. In some embodiments, the processing device is further configured to: receive a request for a second voucher distribution; and determine, in response to receiving the second request for the voucher distribution, whether the second voucher distribution has met the expiration period, wherein, in the instance where the voucher distribution has met the expiration period, automatically redistribute a portion of the resource distribution to the transferor account.

In some embodiments, the resource distribution is transmitted to a holding account.

In some embodiments, the resource voucher is a one-time use resource voucher.

In some embodiments, the resource voucher comprises a computer-readable indicia.

In some embodiments, the resource voucher comprises a printable feature.

In some embodiments, the expiration period is predetermined by a transferor associated with the transferor account.

In some embodiments, the processing device is further configured to: receive a voucher distribution entity identifier to be associated with the voucher distribution; and determine, in response to receiving the voucher distribution entity identifier, whether the voucher distribution is allowed, wherein, in an instance where the requested voucher distribution entity identifier matches the voucher distribution entity identifier, allow the voucher distribution to an entity associated with the voucher distribution entity identifier, or wherein, in an instance where the requested voucher distribution entity identifier does not match the voucher distribution entity identifier, deny the voucher distribution to the entity associated with the voucher distribution entity identifier. In some embodiments, the requested voucher distribution entity identifier comprises a plurality of requested voucher distribution entity identifiers, wherein the voucher distribution is allowed where the voucher distribution entity identifier matches at least one of the plurality of requested voucher distribution entity identifiers.

In some embodiments, and in the instance where the requested voucher distribution entity identifier does not match the voucher distribution entity identifier, automatically redistribute the resource distribution to the transferor account.

In another aspect, a computer program product for generating a personalized voucher comprising automatic return resource distribution at specified events is provided. The computer program product comprises at least one non-transitory computer-readable medium having computer-readable program code portions embodied therein, the computer-readable program code portions which when executed by a processing device are configured to cause the processor to: generate a resource voucher based on a resource distribution from a transferor account to a recipient account, the resource voucher comprising an expiration period; receive a request for a voucher distribution; and determine, in response to receiving the request for the voucher distribution, whether the voucher distribution has met the expiration period, wherein, in an instance where the voucher distribution has met the expiration period, automatically redistribute the resource distribution to the transferor account.

In some embodiments, the processing device is further configured to cause the processor to: receive a request for a voucher distribution, wherein the voucher distribution comprises a portion of the resource distribution; and determine, in response to receiving the request for the voucher distribution, whether the voucher distribution has met the expiration period, wherein, in an instance where the voucher distribution has not met the expiration period, automatically transmit the voucher distribution to an identified account by the recipient account. In some embodiments, the processing device is further configured to cause the processor to: receive a request for a second voucher distribution; and determine, in response to receiving the second request for the voucher distribution, whether the second voucher distribution has met the expiration period, wherein, in an instance where the resource voucher has met the expiration period, automatically redistribute a portion of the resource distribution to the transferor account.

In some embodiments, the resource voucher comprises a computer-readable indicia.

In some embodiments, the expiration period is predetermined by a transferor associated with the transferor account.

In some embodiments, the processing device is further configured to cause the processor to: receive a voucher distribution entity identifier to be associated with voucher distribution; and determine, in response to receiving the voucher distribution entity identifier, whether the voucher distribution is allowed, wherein, in an instance where the requested voucher distribution entity identifier matches the voucher distribution entity identifier, allow the voucher distribution to an entity associated with the voucher distribution entity identifier, or wherein, in an instance where the requested voucher distribution entity identifier does not match the voucher distribution entity identifier, deny the voucher distribution to the entity associated with the voucher distribution entity identifier. In some embodiments, the requested voucher distribution entity identifier comprises a plurality of requested voucher distribution entity identifiers, wherein the voucher distribution is allowed where the voucher distribution entity identifier matches at least one of the plurality of requested voucher distribution entity identifiers. In some embodiments, in the instance where the requested voucher distribution entity identifier does not match the voucher distribution entity identifier, automatically redistribute the resource distribution to the transferor account.

In another aspect, a computer-implemented method for generating a personalized voucher comprising automatic return resource distribution at specified events is provided. The computer-implemented method comprising: generating a resource voucher based on a resource distribution from a transferor account to a recipient account, the resource voucher comprising an expiration period; receiving a request for a voucher distribution; and determining, in response to receiving the request for the voucher distribution, whether the voucher distribution has met the expiration period, wherein, in an instance where the voucher distribution has met the expiration period, automatically redistributing the resource distribution to the transferor account.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment for generating and authenticating use of a voucher in a distributed network, in accordance with an embodiment of the invention;

FIG. 2 illustrates a process flow for generating and authenticating use of a voucher in a distributed network, in accordance with an embodiment of the invention;

FIG. 3 illustrates a process flow for transmitting or redistributing the voucher distribution based on whether the voucher distribution has met the expiration period, in accordance with an embodiment of the invention;

FIG. 4 illustrates a process flow for determining whether to allow a voucher distribution based on a requested voucher distribution entity identifier, in accordance with an embodiment of the invention; and

FIGS. 5A-5B illustrates an exemplary process flow for generating and authenticating use of a voucher in a distributed network, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this invention, a resource is typically stored in a resource repository—a storage location where one or more resources are organized, stored and retrieved electronically using a computing device.

As used herein, a “resource distribution,” or “resource allocation” may refer to any transaction, activities or communication between one or more entities, such as between a transferor account and a recipient account. A resource distribution may refer to any distribution of resources such as, but not limited to, a payment, processing of funds, purchase of goods or services, a return of goods or services, a payment transaction, a credit transaction, or other interactions involving a transferor's resource or account. In some embodiments, a resource distribution or transaction may refer to financial transactions involving direct or indirect movement of funds through traditional paper transaction processing systems (i.e. paper check processing) or through electronic transaction processing systems. Typical financial transactions include person-to-person (P2P) transfers, electronic funds transfers between accounts, point of sale (POS) transactions, automated teller machine (ATM) transactions, internet transactions, online shopping, transactions with a financial institution teller, personal checks, conducting purchases using loyalty/rewards points etc. When discussing that resource distributions or transactions are evaluated it could mean that the transaction has already occurred, is in the process of occurring or being processed, or it has yet to be processed/posted by one or more financial institutions. In some embodiments, a resource distribution or transaction may refer to non-financial activities of the user (e.g., transferor).

As used herein, “voucher distribution” may refer to any transaction, activities or communication between one or more entities, such as between a recipient account and a third party account. A voucher distribution may refer to any distribution of resources such as, but not limited to, a payment, processing of funds, purchase of goods or services, a return of goods or services, a payment transaction, a credit transaction, or other interactions involving a recipient's resource(s) or account. In some embodiments, a voucher distribution or transaction may refer to financial transactions involving direct or indirect movement of funds through traditional paper transaction processing systems (i.e. paper check processing) or through electronic transaction processing systems. Typical financial transactions include person-to-person (P2P) transfers, electronic funds transfers between accounts, point of sale (POS) transactions, automated teller machine (ATM) transactions, internet transactions, online shopping, transactions with a financial institution teller, personal checks, conducting purchases using loyalty/rewards points etc. When discussing that voucher distributions or transactions are evaluated it could mean that the transaction has already occurred, is in the process of occurring or being processed, or it has yet to be processed/posted by one or more financial institutions. In some embodiments, a voucher distribution or transaction may refer to non-financial activities of the user (e.g., recipient).

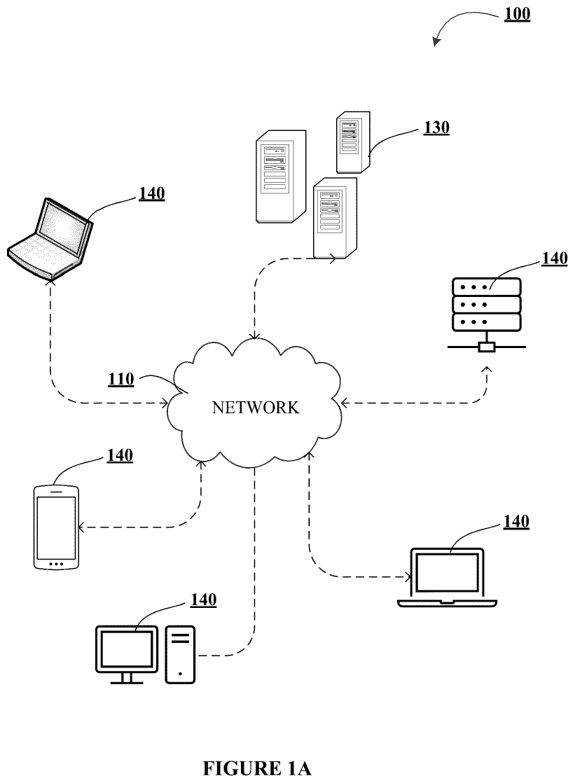

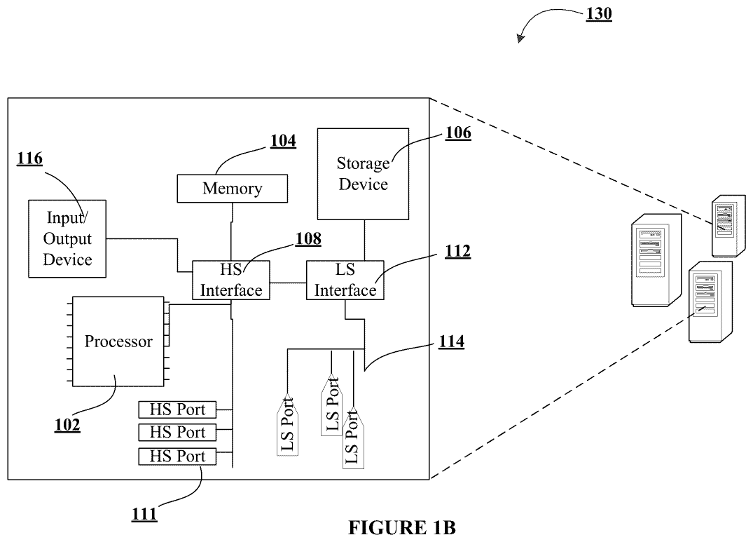

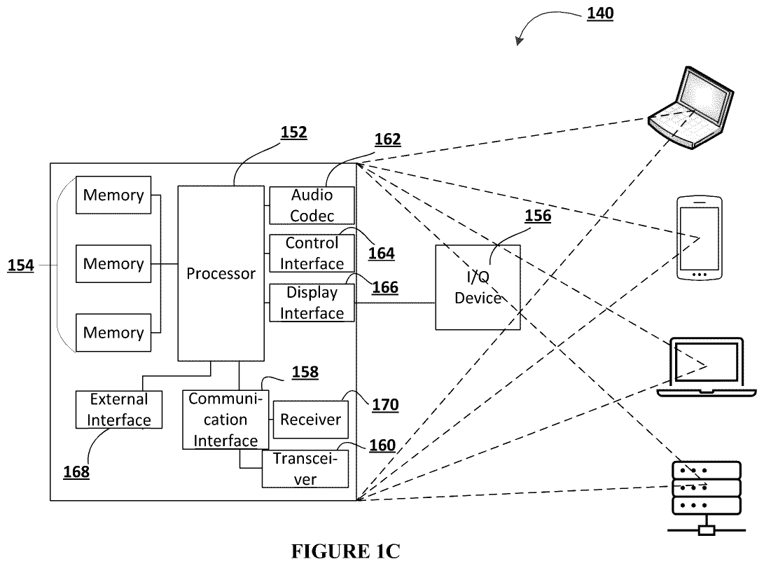

As described in further detail herein, the present invention provides a solution to the above-referenced problems in the field of technology by generating an accurate and efficient system for tracking, authenticating, and controlling resource distributions (e.g., resource distribution, voucher distributions, and/or the like) within a plurality of accounts. The present invention solves this technical problem by implementing a distribution authentication system, like that shown as system 130 in FIGS. 1A-1C. For instance, the distribution authentication system acts to authenticate and control distributions, such as resource distributions and voucher distributions, by using a plurality of data that is used to generate a resource voucher. Such a resource voucher may be based on certain delineated requirements of the distributions, which may be pre-determined by a transferor associated with a transferor account of the original resource distribution. The distribution authentication system may authenticate a distribution (e.g., a voucher distribution) from the recipient account and whether the voucher distribution meets a plurality of requirements set forth within the resource voucher. In some embodiments, and where the voucher distribution does not meet the plurality of requirements, the distribution authentication system may automatically redistribute the resource distribution back to the transferor account such that the voucher distribution is no longer available.

Accordingly, the distribution authentication system works by generating a resource voucher based on a resource distribution from a transferor account to a recipient account, the resource voucher comprising an expiration period; receiving a request for a voucher distribution; and determining, in response to receiving the request for the voucher distribution, whether the voucher distribution has met the expiration period, wherein, in an instance where the voucher distribution has met the expiration period, automatically redistributing the resource distribution to the transferor account.

What is more, the present invention provides a technical solution to a technical problem. As described herein, the technical problem includes the failure of prior systems to accurately and efficiently track, authenticate, and control resource distributions in a network, where such a resource distribution may be controlled by different accounts at a plurality of times. The technical solution presented herein allows for a distribution authentication system to accurately, efficiently, and in real-time track, authenticate, and control distributions (e.g., resource distributions and/or voucher distributions), even where the distributions are controlled and/or distributed from a plurality of accounts. In particular, the distribution authentication system is an improvement over existing solutions to the authentication and control of the distributions in a network where a plurality of accounts may control the distributions (i) with fewer steps to achieve the solution, thus reducing the amount of computing resources, such as processing resources, storage resources, network resources, and/or the like, that are being used (e.g., by using fewer steps to ensure tracking and authentication within a single system rather than a distributed network of multiple systems to track each account and individual distribution); (ii) providing a more accurate solution to problem, thus reducing the number of resources required to remedy any errors made due to a less accurate solution (e.g., by providing a resource voucher that comprises data specific for each distribution, including the voucher distribution, which data may be compared against each instance of the distribution(s) in order to authenticate and control the distribution(s)); (iii) removing manual input and waste from the implementation of the solution, thus improving speed and efficiency of the process and conserving computing resources (e.g., removing the manual input of the resource voucher at the instance where a voucher distribution is intended to take place, the distribution authentication system allows for faster speed and efficiency in authenticating the voucher distribution and controlling the voucher distribution and/or resource distribution). Furthermore, the technical solution described herein uses a rigorous, computerized process to perform specific tasks and/or activities that were not previously performed. In specific implementations, the technical solution bypasses a series of steps previously implemented, thus further conserving computing resources.

FIGS. 1A-1C illustrate technical components of an exemplary distributed computing environment for generating and authenticating use of a voucher in a distributed network 100, in accordance with an embodiment of the invention. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

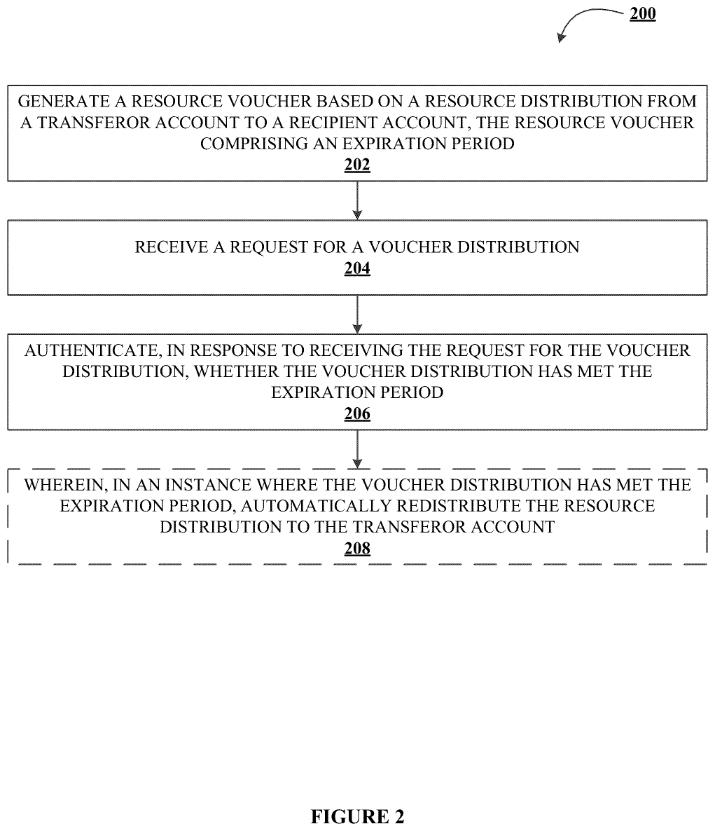

FIG. 2 illustrates a process flow for generating and authenticating use of a voucher in a distributed network, in accordance with an embodiment of the invention. In some embodiments, a system (e.g., similar to one or more of the systems described herein with respect to FIGS. 1A-1C) may perform one or more of the steps of process flow 200. For example, a distribution authentication system (e.g., the system 130 described herein with respect to FIGS. 1A-1C) may perform the steps of process flow 200.

As shown in block 202, the process flow 200 may include the step of generating a resource voucher based on a resource distribution from a transferor account to a recipient account, the resource voucher comprising an expiration period. By way of non-limiting example, the resource distribution may refer to a distribution of a resource(s) transmitted between a transferor account and a recipient account.

In some embodiments and by way of non-limiting example, the resource voucher may refer to a voucher and/or other such identifier comprising data of a resource distribution and/or voucher distribution. For instance, the resource voucher may comprise at least one of a resource distribution amount, a transferor account identifier associated with a transferor account, a recipient account identifier associated with a recipient account, a requested voucher distribution entity identifier for which the voucher distribution may be transmitted to from the resource account, and/or an expiration period for the voucher distribution. In some embodiments, the resource voucher may comprise a gift card, a coupon, and/or other such resource distribution mechanisms that may be used to complete a resource transaction.

In some embodiments, the resource voucher may comprise data regarding an expiration period. By way of non-limiting example, the expiration period may indicate a specified day that the voucher distribution is no longer able to be used and/or is void (e.g., a specified date, a specified time of day, a specified year, and/or the like), which may be pre-determined by the transferor associated with the transferor account which generated the resource distribution amount for the resource voucher. In some embodiments, the expiration period may be determined (e.g., pre-determined) by the transferor of the transferor account at the time the resource distribution is generated. In some embodiments, the expiration period may also be pre-determined by the distribution authentication system to be a predetermined period from the time the resource voucher is generated (e.g., a year from the resource voucher's generation, half a year, and/or the like which may be used to indicate a time period of counting down the availability for the voucher distribution to be used). In some embodiments, the expiration period to count down the availability of the voucher distribution (e.g., an expiration period of a year, half a year, and/or the like) may also be predetermined by the transferor associated with the transferor account, rather than identifying a specific date for the expiration period to end.

In some embodiments, the resource distribution may be transmitted to a different account from the recipient account, such as a holding account. By way of non-limiting example, such a holding account may be akin to an escrow account and/or the like, where the resource distribution may be held until certain specified events have occurred, such as whether an expiration period has been met at a time when the recipient account has identified a voucher distribution entity. In some embodiments, and by way of non-limiting example, if the expiration period has been met at a time when the recipient account has identified the voucher distribution entity, the distribution authentication system may redistribute the resource distribution from the holding account to the transferor account. In some embodiments, and by way of non-limiting example, if the expiration period has not been met at a time when the recipient account has identified the voucher distribution entity (and in those embodiments where the voucher distribution entity matches a voucher distribution entity requested by the transferor account), the distribution authentication system may transmit the resource distribution to the recipient account which will then be transmitted as a voucher distribution to the voucher distribution entity.

As shown in block 204, the process flow 200 may include the step of receiving a request for a voucher distribution. By way of non-limiting example, a voucher distribution may refer to a distribution of resources from the recipient account (e.g., associated with the resource distribution from the transferor account to the recipient account) to a third party entity, such as a voucher distribution entity. By way of non-limiting example, such a third party entity may comprise at least one of a merchant, a store, a business, and/or the like where resources are exchanged.

In some embodiments, the request for a voucher distribution may be transmitted from the recipient account from a user device (e.g., a user device associated with the recipient account) over a network, such as network 110 of FIG. 1A-1C. The request may comprise an entity identifier, such as a voucher distribution entity identifier, that identifies what entity the voucher distribution is intended to be transmitted to. In some embodiments, the request for the voucher distribution may also comprise an amount of the voucher distribution to be distributed (e.g., the full amount of the voucher distribution and/or a portion of the voucher distribution). In some embodiments, the request for the voucher distribution may also comprise a time for the voucher distribution, such as an immediate distribution, a point of sale time, a pre-determined future time, and/or the like.

In some embodiments, the time for the voucher distribution may be determined to be the time at which the voucher distribution will actually occur (e.g., a future point of sale) and/or the time at which the voucher distribution was actually requested (e.g., the recipient account may submit the request for the voucher distribution before the expiration period, but the actual voucher distribution may not occur until after the expiration period has lapsed). In some embodiments, the distribution authentication system may determine that the time for the voucher distribution, and for purposes of the expiration period determination, is set at the time of the request for the voucher distribution. In this manner, the distribution authentication system may allow a future voucher distribution after the expiration period has lapsed, where the request for the voucher distribution was received before the expiration period lapsed.

As shown in block 206, the process flow 200 may include the step of authenticating, in response to receiving the request for the voucher distribution, whether the voucher distribution has met the expiration period. By way of non-limiting example, once the request for the voucher distribution has been received by the distribution authentication system, the distribution authentication system may authenticate and/or determine whether the voucher distribution has met the expiration period when the voucher distribution is set to occur (e.g., when the request for the voucher distribution was received and/or when the request identifies at what time the voucher distribution is set to be transmitted from the recipient account) and/or whether the voucher distribution entity identifier matches a requested voucher distribution entity identifier pre-determined by the transferor account. By way of non-limiting example, the resource voucher may refer to a voucher (e.g., gift card, coupon, and/or the like) that comprises data regarding the set of distributions that may take place (i.e., the resource distribution and/or the voucher distribution), which may include the expiration period, the requested voucher distribution entity identifier (e.g., that is pre-determined by the transferor account), and/or the like that may be described herein.

In some embodiments and as shown in block 208, the process flow 200 may include the step of automatically, in an instance where the voucher distribution has met the expiration period, redistributing the resource distribution to the transferor account. By way of non-limiting example, the redistribution of the resource distribution may refer to the re-transmittal of the resource distribution back to the transferor account (e.g., back to the original account that generated the resource distribution). In some embodiments, the redistribution of the resource distribution may comprise the entire resource distribution that was originally distributed, only a portion of the resource distribution (e.g., where a portion of the voucher distribution was already transmitted by the recipient account), and/or the like. By way of non-limiting example, the distribution authentication system may redistribute the resource distribution automatically and immediately to the transferor account once the distribution authentication system determines that the voucher distribution has met the expiration period.

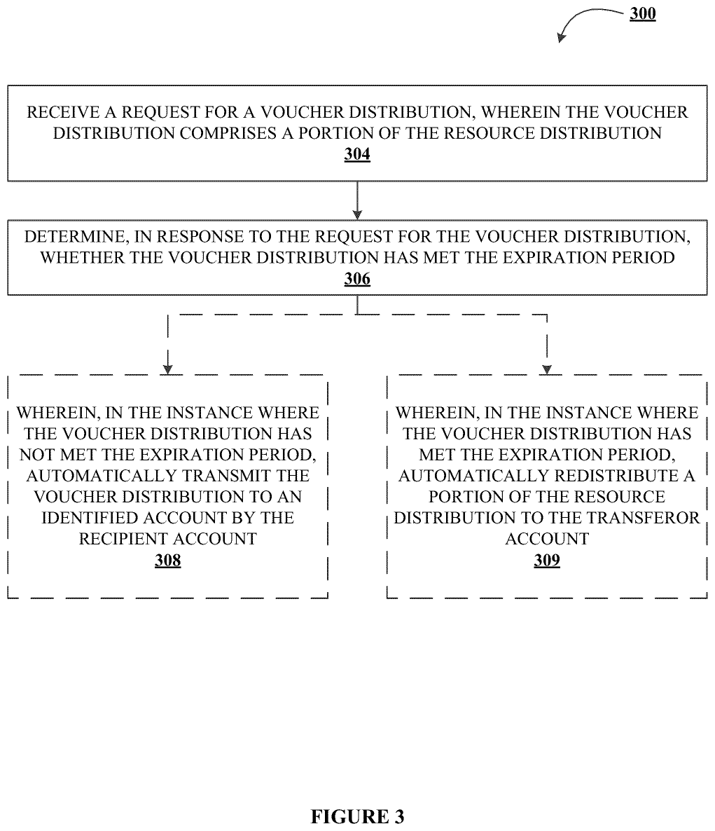

In some embodiments, the distribution authentication system may distribute the resource distribution to a different account instead of the transferor account, when the voucher distribution has met the expiration period. By way of non-limiting example, the distribution authentication system may transmit the resource distribution to a different account (e.g., such as a holding account) for safekeeping until a specified time period has lapsed and the distribution authentication system can confirm that the expiration period has passed and that the resource distribution and/or a portion of the resource distribution should be redistributed back to the transferor account. In this manner, the distribution authentication system may confirm that the expiration period and/or another specified event (e.g., whether the voucher distribution entity identifier that was generated and/or determined by the recipient account did not match the requested voucher distribution entity identifier that was predetermined by the transferor account) before redistributing the resource distribution back to the transferor account. Such an embodiment of redistributing the resource distribution back to the transferor account is described in further detail below with respect to FIG. 3.

In some embodiments, the distribution authentication system may transmit the resource distribution to a different account associated with the transferor account (e.g., to a savings account of the transferor account rather than the checking account of the transferor account that originally generated the resource distribution) and/or an account identified by the transferor as an optional recipient if a specific event occurs, such as the expiration period being met and/or the voucher distribution entity identifier not matching the requested voucher distribution entity identifier, where the account identified by the transferor may comprise a different intended third party to receive the resource distribution (e.g., charity, different recipient account, and/or the like).

FIG. 3 illustrates a process flow for transmitting or redistributing the voucher distribution based on whether the voucher distribution has met the expiration period, in accordance with an embodiment of the invention. In some embodiments, a system (e.g., similar to one or more of the systems described herein with respect to FIGS. 1A-1C) may perform one or more of the steps of process flow 300. For example, a distribution authentication system (e.g., the system 130 described herein with respect to FIGS. 1A-1C) may perform the steps of process flow 300.

As shown in block 304, the process flow 300 may include the step of receiving a request for a voucher distribution, wherein the voucher distribution comprises a portion of the resource distribution. By way of non-limiting example, the distribution authentication system may receive a request for a voucher distribution from a recipient account, where the recipient account may identify the voucher distribution entity that the voucher distribution is intended to be transmitted to. In some embodiments, the request for the voucher distribution may further comprise an amount of the voucher distribution to be distributed to the voucher distribution entity, where the amount of the voucher distribution may comprise the full amount of the original voucher distribution, a portion of the voucher distribution, and/or the like. However, and where a previous portion of the voucher distribution has already been transmitted, the distribution authentication system may only receive an amount of the voucher distribution from the recipient account as a portion of the voucher amount (e.g., a portion of the resource distribution that was originally transmitted to the recipient account).

As shown in block 306, the process flow 300 may include the step of determining, in response to the request for the voucher distribution, whether the voucher distribution has met the expiration period. By way of non-limiting example, the distribution authentication system may determine whether the voucher distribution has met the expiration period by comparing the request for the voucher distribution against the data of the resource voucher, where the resource voucher may comprise an expiration period identified and/or generated by the transferor account.

In some embodiments, and before the voucher distribution is distributed from the recipient account, the distribution authentication system may determine that voucher distribution has met the expiration period identified within the resource voucher. By way of non-limiting example, and where the voucher distribution has met and/or exceeded the expiration period, the distribution authentication system may disallow the voucher distribution from being distributed from the recipient account. In some embodiments, and where the voucher distribution has not met the expiration period, the distribution authentication system may allow the voucher distribution to be distributed from the recipient account. In some embodiments, and based on the allowance of the voucher distribution, the entire amount of the voucher distribution and/or only a portion of the voucher distribution may be distributed and/or transmitted from the recipient account to a different account (e.g., the voucher distribution entity identified by the recipient account).

In some embodiments, and as shown in block 308, the process flow 300 may include the step of automatically transmitting, in the instance where the voucher distribution has not met the expiration period, the voucher distribution to an identified account by the recipient account. By way of non-limiting example, the recipient account may identify a third party (e.g., a merchant, company, different third party, and/or the like) to transmit all or part of the voucher distribution by requesting a voucher distribution that comprises a voucher distribution entity identifier for the third party.

In some embodiments, the voucher distribution may be automatically transmitted to the voucher distribution entity associated with the voucher distribution entity identifier. By way of non-limiting example, the distribution authentication system may first authenticate that the voucher distribution has not met the expiration period at the time the request for the voucher distribution has been made by the recipient account, and when the distribution authentication system confirms the expiration period has not been met, the distribution authentication system may automatically transmit the voucher distribution to the third party. In some embodiments, and where the request for the voucher distribution comprises an indication of a future voucher distribution (e.g., a voucher distribution at a future, specified time), the distribution authentication system may automatically confirm the future voucher distribution (e.g., based on the request for the voucher distribution not meeting the expiration period) and may automatically transmit the voucher distribution at said future time.

In some embodiments, and as shown in block 309, the process flow 300 may include the step of automatically redistributing, in the instance where the voucher distribution has met the expiration period, a portion of the resource distribution to the transferor account. By way of non-limiting example, the distribution authentication system may determine that a voucher distribution has met the expiration period at a time the request for the voucher distribution has been received by the distribution authentication system. For instance, and in response to determining the voucher distribution has met the expiration period, the distribution authentication system may redistribute all of and/or only a portion (e.g., the entire portion left in the voucher distribution) of resource distribution back to the transferor account. In some embodiments, such a redistribution of the resource distribution may be automatic and immediate after the determination that the voucher distribution has met the expiration period.

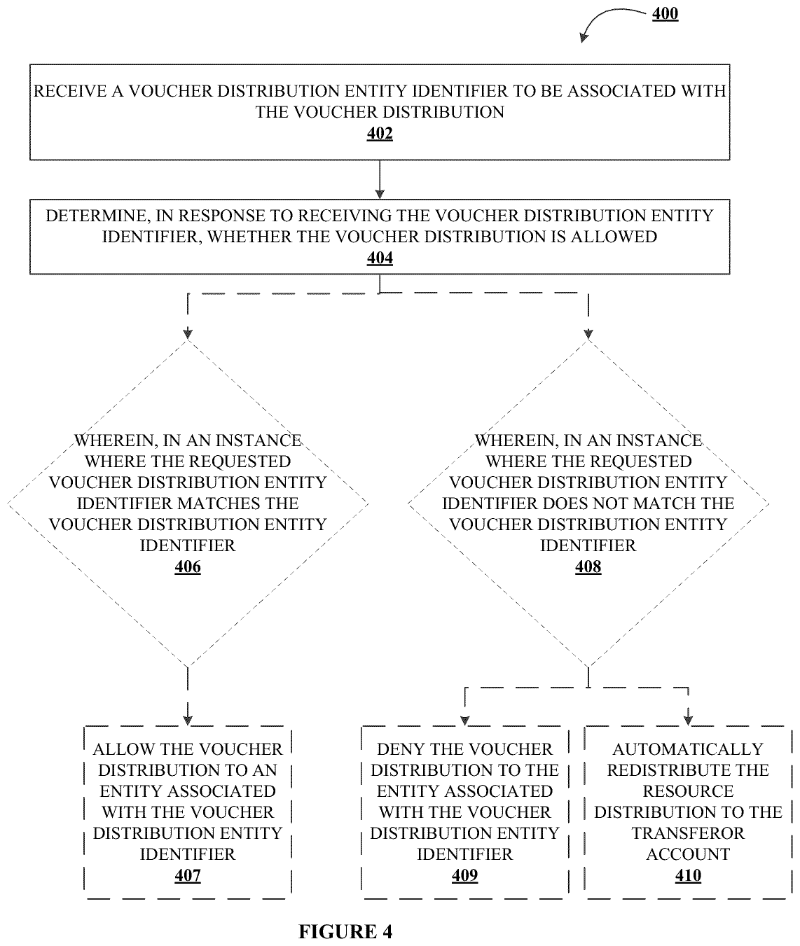

FIG. 4 illustrates a process flow for determining whether to allow a voucher distribution based on a requested voucher distribution entity identifier, in accordance with an embodiment of the invention. In some embodiments, a system (e.g., similar to one or more of the systems described herein with respect to FIGS. 1A-1C) may perform one or more of the steps of process flow 400. For example, a distribution authentication system (e.g., the system 130 described herein with respect to FIGS. 1A-1C) may perform the steps of process flow 400.

As shown in block 402, the process flow 400 may include the step of receiving a voucher distribution entity identifier to be associated with the voucher distribution. By way of non-limiting example, the voucher distribution entity identifier may uniquely identify an entity that the voucher distribution is to be distributed to. For instance, the voucher distribution entity identifier may be identified by the recipient account as an intended recipient of the voucher distribution.

In some embodiments, the distribution authentication system may receive a voucher distribution entity identifier from a recipient account, which may identify the entity for which the voucher distribution and/or a portion of the voucher distribution is intended for distribution. The voucher distribution entity identifier may be received from a user device associated with the recipient of the recipient account, where the voucher distribution entity identifier may be transmitted to the distribution authentication system over a network, such as network 110 of FIGS. 1A-1C.

In some embodiments, the recipient account may identify and/or generate the voucher distribution entity identifier by walking into a brick and mortar location of the voucher distribution entity and requesting a resource transaction take place (e.g., request a transaction of goods and/or services by offering the voucher distribution in exchange). Based on this request that the resource transaction take place, the distribution authentication system may determine the voucher distribution entity identifier that is associated with the entity that has input the resource voucher (e.g., scanned the resource voucher).

In some embodiments, the recipient account may identify and/or generate the voucher distribution entity identifier by accessing a voucher distribution entity's website and requesting a resource transaction through the voucher distribution entity's website (e.g., by submitting a resource transaction to a server run by the voucher distribution entity).

In some embodiments, and in conjunction with the voucher distribution entity identifier, the distribution authentication system may also receive a voucher distribution amount for the voucher distribution to the voucher distribution entity. By way of non-limiting example, such a voucher distribution amount may comprise the full amount of the resource distribution (which, herein, also describes the full amount of the voucher distribution) which can be distributed and/or transmitted to the voucher distribution entity. In some embodiments, the voucher distribution amount may comprise a partial amount or a portion of the resource distribution (e.g., a portion of the voucher distribution available for the recipient account). In this manner, the partial amount of the voucher distribution, once transmitted to the voucher distribution entity, may comprise a leftover portion of the voucher distribution for the recipient account to spend and/or use at a later time (e.g., where the expiration period has not been met).

As shown in block 404, the process flow 400 may include the step of determining, in response to receiving the voucher distribution entity identifier, whether the voucher distribution is allowed. By way of non-limiting example, the distribution authentication system may determine whether the voucher distribution should be allowed, after receiving the voucher distribution entity identifier, and/or by determining whether at the expiration period that was previously pre-determined by the transferor account has been met by the voucher distribution.

In some embodiments, the distribution authentication system may determine whether requested voucher distribution entity matches a voucher distribution entity identifier, where the requested voucher distribution entity has been predetermined by the transferor account in a similar manner to the expiration period.

In some embodiments, and as shown in blocks 406-407, the process flow 400 may include the determination that in an instance where the requested voucher distribution entity identifier matches the voucher distribution entity identifier, the distribution authentication system may allow the voucher distribution to be transmitted to the entity associated with the voucher distribution entity identifier. By way of non-limiting example, the distribution authentication system may determine a requested voucher distribution entity identifier based on the resource voucher comprising the requested voucher distribution entity identifier which was pre-determined by the transferor account at the time the resource voucher was generated, and the resource distribution was transmitted. By way of non-limiting example, the distribution authentication system may determine that the voucher distribution entity identifier submitted by the recipient account matches the requested voucher distribution entity identifier submitted by the transferor account based on an exact matching.

In some embodiments, the transferor account may submit a plurality of potential requested voucher distribution entity identifiers which may be used by the distribution authentication system to determine whether the voucher distribution entity identifier matches at least one of the potential requested voucher distribution entity identifiers before the voucher distribution is allowed.

In some embodiments, and as shown in block 408, the process flow 400 may include the determination that the requested voucher distribution entity identifier does not match the voucher distribution entity identifier. In some embodiments, based on the determination of block 408, and as shown as block 409, the process flow 400 may include the step of denying the voucher distribution to the entity associated with the voucher distribution entity. In some embodiments, based on the determination of block 408, and as shown as block 410, the process flow 400 may include the step of automatically redistributing the resource distribution to the transferor account. By way of non-limiting example, the distribution authentication system may use the requested voucher distribution entity identifier that was generated by the transferor account to identify whether to allow the voucher distribution to the voucher distribution entity associated with the voucher distribution entity identifier generated by the recipient account. Such a determination may be based on the exact matching of the voucher distribution entity identifier to the requested voucher distribution entity identifier, where the requested voucher distribution entity identifier may comprise a plurality of potential requested voucher distribution entity identifiers for which the transferor account has identified as potential recipients of the voucher distribution.

However, and in some embodiments, where the voucher distribution entity identifier does not match the requested voucher distribution entity identifier (and/or plurality of potential requested voucher distribution entity identifiers), the distribution authentication system may deny the voucher distribution to the voucher distribution entity associated with the voucher distribution entity identifier. In some embodiments, the denial of the voucher distribution may further comprise automatically redistributing the resource distribution (e.g., and/or a portion of the resource distribution where a portion of the voucher distribution was already transmitted) to the transferor account.

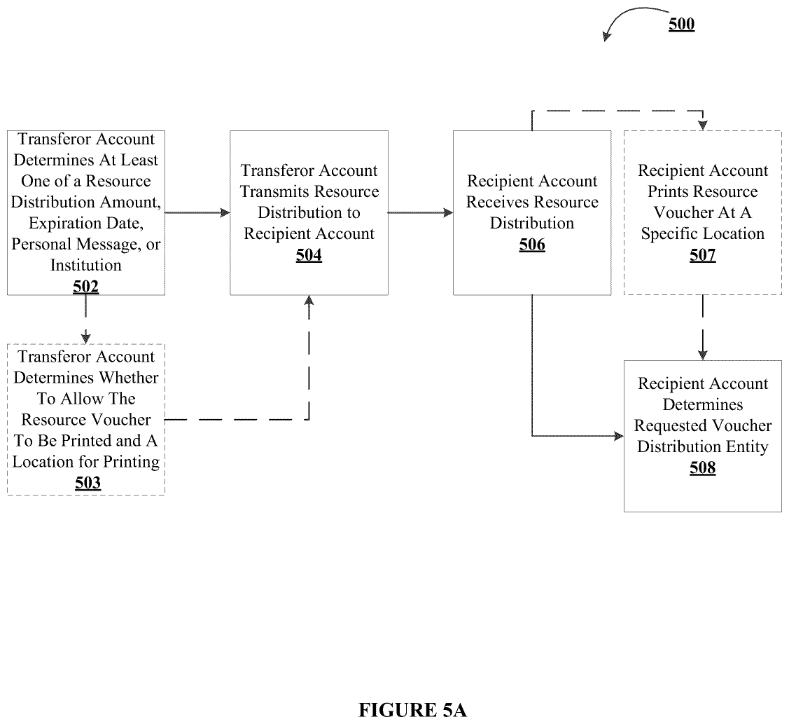

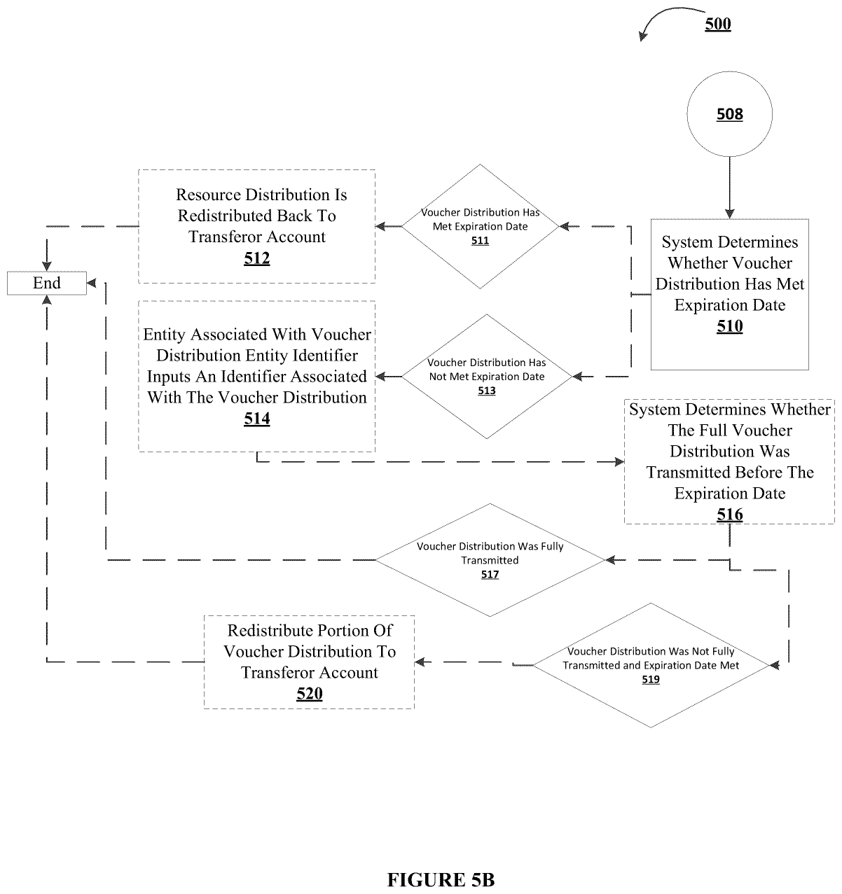

FIGS. 5A-5B illustrates a process flow for generating and authenticating use of a voucher in a distributed network, in accordance with an embodiment of the invention. In some embodiments, a system (e.g., similar to one or more of the systems described herein with respect to FIGS. 1A-1C) may perform one or more of the steps of process flow 500. For example, a distribution authentication system (e.g., the system 130 described herein with respect to FIGS. 1A-1C) may perform the steps of process flow 500.

As shown in block 502, the process flow 500 may include the step of a transferor account determining at least one of a resource distribution amount, an expiration period and/or expiration date, personal message, or institution, as part of the generation for the resource voucher. By way of non-limiting example, the transferor account may determine a plurality of factors and/or requirements for the voucher distribution to be allowed. Such requirements may comprise at least one of a resource distribution amount which may also indicate the voucher distribution amount; an expiration period and/or expiration date of the voucher distribution which may automatically redistribute the any left over voucher distribution back to the transferor account as a redistribution of the resource distribution; a personal message from the transferor to the recipient account; and/or an institution identified by the transferor account for the recipient account to (1) print out the resource voucher, (2) transmit the voucher distribution (e.g., requested voucher distribution entity identifier), or (3) for which the resource distribution is to be transmitted to and/or from. In some embodiments, the resource voucher may be a one-time voucher and may only be used a single time for a single voucher distribution (e.g., either all of the voucher distribution is used at one time or only a portion of the voucher distribution is used at a first time and the portion of the voucher distribution left over is redistributed back to the transferor account and/or an account identified by the transferor account).

In some embodiments, and as shown in block 503, the process flow 500 may include the step of the transferor account determining whether to allow the voucher distribution to be printed and a location for printing. By way of non-limiting example, the resource voucher may comprise a computer-readable indica which may be generated into a printable format, such as a QR code that may be printed by the recipient. In some embodiments, the transferor account may also indicate a location that the recipient account is required to print the resource voucher, such as a financial institution and/or other such trusted institutions of the transferor account. In some embodiments, the transferor account may indicate that the resource voucher may be printed anywhere and/or at the recipient's home.

As shown in blocks 504-506, the process flow 500 may include the step of the transferor account transmitting the resource distribution to the recipient account and the recipient account receiving the resource distribution. By way of non-limiting example, the distribution authentication system may transmit the resource distribution (e.g., the amount of the resource distribution determined by the transferor account) to the recipient account from the transferor account. Once received by the recipient account, the resource distribution may be used to generate the voucher distribution which may be used by the recipient account and may be transferred to a plurality of third parties from the recipient account.

In some embodiments, and as shown in block 507, the process flow 500 may include the step of the recipient account printing the resource voucher at a specific location. By way of non-limiting example, the specific location for printing of the resource voucher may comprise a financial institution identified by the transferor account, another institution identified by the transferor account, which the transferor account identified at the time the resource voucher was generated.

As shown in block 508, the process flow 500 may include the step of the recipient account determining the requested voucher distribution entity. By way of non-limiting example, the transferor account may generate the requested voucher distribution entity identifier and/or a plurality of potential requested voucher distribution entity identifiers which the voucher distribution may only be transmitted to. For instance, such requested voucher distribution entity identifier(s) and/or potential requested voucher distribution entity identifiers may comprise entity identifiers of specified merchants, companies, third parties, and/or the like that the transferor wishes the recipient account to use the voucher distribution for. In this manner, the distribution authentication system may verify that the recipient account is following the directions of the transferor account before allowing the distribution voucher to be transmitted.

As shown in block 510, the process flow 500 may include the step of the distribution authentication system determining whether the voucher distribution has met the expiration date and/or expiration period identified by the resource voucher. By way of non-limiting example, the distribution authentication system may determine whether the voucher distribution has met the expiration date and or expiration period by analyzing the resource voucher and its associated data (e.g., data regarding the expiration date and/or period that was identified by the transferor account) against the voucher distribution request which may comprise a timestamp for the request. For instance, the voucher distribution request may comprise a timestamp (e.g., date and time) of the request which may be compared to the expiration date and/or period on the resource voucher to determine if the timestamp of the voucher distribution request meets or exceeds the expiration date and/or period.

In some embodiments, and as shown in block 511, the process flow 500 may include the step that the distribution authentication system has determined that the voucher distribution meets the expiration date and/or expiration period. In some embodiments, and as shown in block 512, the process flow 500 may include the step of the resource distribution being redistributed back to the transferor account. For instance, and based on block 511 where the voucher distribution has been determined as meeting the expiration date, the distribution authentication system may redistribute the resource distribution back to the transferor account and the process may end.

In some embodiments, and as shown in block 513, the process flow 500 may include the step of the voucher distribution not meeting the expiration date and/or expiration period. In some embodiments, and as shown in block 514, the process flow 500 may include the step of the entity associated with the voucher distribution entity identifier inputting an identifier associated with the voucher distribution. By way of non-limiting example, the entity associated with the voucher distribution entity identifier may input an identifier associated with the voucher distribution (e.g., may scan the QR code and/or computer-readable indicia) and transmit the data to the distribution authentication system in order for the voucher distribution entity to be authenticated to receive the voucher distribution. In some embodiments, and based on the entity inputting the identifier associated with the voucher distribution, the distribution authentication system may determine whether the voucher distribution should be transmitted. For example, the distribution authentication system may allow the voucher distribution where the voucher distribution still comprises an amount, where the expiration period and/or expiration date has not been met, and/or where the voucher distribution entity identifier matches a requested voucher distribution entity identifier.

In some embodiments, and as shown in block 516, the process flow 500 may include the step of the distribution authentication system determining whether the full voucher distribution was transmitted before the expiration date and/or expiration period. By way of non-limiting example, and where the full voucher distribution was fully transmitted either before the expiration date or before the current request for the voucher distribution, the distribution authentication system may deny the voucher distribution to the entity associated with the voucher distribution entity identifier. Such an embodiment may be shown in block 517 of process flow 500.

In some embodiments, and as shown in block 519, the process flow 500 may include the step of the distribution authentication system determining that the voucher distribution was not fully transmitted and the expiration date was met. By way of non-limiting example, and as shown in block 520, the process 500 may further include the step of the redistribution of the portion of the voucher distribution to the transferor account where the expiration date was met, and where a portion of the voucher distribution was left. Thus, and by way of non-limiting example, the excess portion of the voucher distribution may be redistributed as a resource distribution back to the transferor account and/or may be distributed as a voucher distribution to a third party identified by the transferor account in such circumstances.

However, and by way of some embodiments, where the expiration date has not been met and where a portion of the voucher distribution was not fully transmitted at the time the current request for the voucher distribution was received by the distribution authentication system, the distribution authentication system may determine if the entity associated with the voucher distribution entity identifier should receive the voucher distribution. For instance, the distribution authentication system may compare the identifier transmitted by the voucher distribution entity that received the resource voucher (e.g., scanned the resource voucher) to the requested voucher distribution entity identifier generated by the transferor account to identify whether the identifiers match. In the instance where the identifiers to do match, the distribution authentication system may transmit the voucher distribution (e.g., and/or a portion of the voucher distribution) to the voucher distribution entity that received the resource voucher.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for generating a personalized voucher comprising automatic return resource distribution at specified events, the system comprising;
a memory device with computer-readable program code stored thereon;
at least one processing device operatively coupled to the at least one memory device and the at least one communication device, wherein executing the computer-readable code is configured to cause the at least one processing device to:
generate a resource voucher based on a resource distribution from a transferor account to a recipient account, the resource voucher comprising an expiration period;
receive a request for a voucher distribution; and
authenticate, in response to receiving the request for the voucher distribution, whether the voucher distribution has met the expiration period,
wherein, in the instance where the voucher distribution has met the expiration period, automatically redistribute the resource distribution to the transferor account.

2. The system of claim 1, wherein the processing device is further configured to:
receive a request for a voucher distribution, wherein the voucher distribution comprises a portion of the resource distribution; and
determine, in response to receiving the request for the voucher distribution, whether the voucher distribution has met the expiration period,
wherein, in the instance where the voucher distribution has not met the expiration period, automatically transmit the voucher distribution to an identified account by the recipient account.

3. The system of claim 2, wherein the processing device is further configured to:
receive a request for a second voucher distribution; and
determine, in response to receiving the second request for the voucher distribution, whether the second voucher distribution has met the expiration period,
wherein, in the instance where the voucher distribution has met the expiration period, automatically redistribute a portion of the resource distribution to the transferor account.

4. The system of claim 1, wherein the resource distribution is transmitted to a holding account.

5. The system of claim 1, wherein the resource voucher is a one-time use resource voucher.

6. The system of claim 1, wherein the resource voucher comprises a computer-readable indicia.

7. The system of claim 1, wherein the resource voucher comprises a printable feature.

8. The system of claim 1, wherein the expiration period is predetermined by a transferor associated with the transferor account.

9. The system of claim 1, wherein the processing device is further configured to:
receive a voucher distribution entity identifier to be associated with the voucher distribution; and
determine, in response to receiving the voucher distribution entity identifier, whether the voucher distribution is allowed,
wherein, in an instance where the requested voucher distribution entity identifier matches the voucher distribution entity identifier, allow the voucher distribution to an entity associated with the voucher distribution entity identifier, or
wherein, in an instance where the requested voucher distribution entity identifier does not match the voucher distribution entity identifier, deny the voucher distribution to the entity associated with the voucher distribution entity identifier.

10. The system of claim 9, wherein the requested voucher distribution entity identifier comprises a plurality of requested voucher distribution entity identifiers, wherein the voucher distribution is allowed where the voucher distribution entity identifier matches at least one of the plurality of requested voucher distribution entity identifiers.

11. The system of claim 9, wherein, in the instance where the requested voucher distribution entity identifier does not match the voucher distribution entity identifier, automatically redistribute the resource distribution to the transferor account.

12. A computer program product for generating a personalized voucher comprising automatic return resource distribution at specified events, wherein the computer program product comprises at least one non-transitory computer-readable medium having computer-readable program code portions embodied therein, the computer-readable program code portions which when executed by a processing device are configured to cause the processor to:
generate a resource voucher based on a resource distribution from a transferor account to a recipient account, the resource voucher comprising an expiration period;
receive a request for a voucher distribution; and
determine, in response to receiving the request for the voucher distribution, whether the voucher distribution has met the expiration period,
wherein, in an instance where the voucher distribution has met the expiration period, automatically redistribute the resource distribution to the transferor account.

13. The computer program product of claim 12, wherein the processing device is further configured to cause the processor to:
receive a request for a voucher distribution, wherein the voucher distribution comprises a portion of the resource distribution; and
determine, in response to receiving the request for the voucher distribution, whether the voucher distribution has met the expiration period,
wherein, in an instance where the voucher distribution has not met the expiration period, automatically transmit the voucher distribution to an identified account by the recipient account.

14. The computer program product of claim 13, wherein the processing device is further configured to cause the processor to:
receive a request for a second voucher distribution; and
determine, in response to receiving the second request for the voucher distribution, whether the second voucher distribution has met the expiration period,
wherein, in an instance where the resource voucher has met the expiration period, automatically redistribute a portion of the resource distribution to the transferor account

15. The computer program product of claim 12, wherein the resource voucher comprises a computer-readable indicia.

16. The computer program product of claim 12, wherein the expiration period is predetermined by a transferor associated with the transferor account.

17. The computer program product of claim 12, wherein the processing device is further configured to cause the processor to:
receive a voucher distribution entity identifier to be associated with voucher distribution; and
determine, in response to receiving the voucher distribution entity identifier, whether the voucher distribution is allowed,
wherein, in an instance where the requested voucher distribution entity identifier matches the voucher distribution entity identifier, allow the voucher distribution to an entity associated with the voucher distribution entity identifier, or
wherein, in an instance where the requested voucher distribution entity identifier does not match the voucher distribution entity identifier, deny the voucher distribution to the entity associated with the voucher distribution entity identifier.

18. The computer program product of claim 17, wherein the requested voucher distribution entity identifier comprises a plurality of requested voucher distribution entity identifiers, wherein the voucher distribution is allowed where the voucher distribution entity identifier matches at least one of the plurality of requested voucher distribution entity identifiers.

19. The computer program product of claim 18, wherein, in the instance where the requested voucher distribution entity identifier does not match the voucher distribution entity identifier, automatically redistribute the resource distribution to the transferor account.

20. A computer-implemented method for generating a personalized voucher comprising automatic return resource distribution at specified events, the computer-implemented method comprising:
generating a resource voucher based on a resource distribution from a transferor account to a recipient account, the resource voucher comprising an expiration period;
receiving a request for a voucher distribution; and
determining, in response to receiving the request for the voucher distribution, whether the voucher distribution has met the expiration period,
wherein, in an instance where the voucher distribution has met the expiration period, automatically redistributing the resource distribution to the transferor account.
